(19) United States
(12) Patent Application Publication
(10) Pub. No.: US 2007/0138159 A1
(43) Pub. Date: Jun. 21, 2007

(54) Optimization of a heating device

(75) Inventors: Frederic Pierron, Rambouillet (FR); Olivier Colette, Le Mesnil St Denis (FR)

Correspondence Address: Valeo Climate Control Corp.;Intellectual Property Dept., 4100 North Atlantic Boulevard, Auburn Hills, MI, 48326, US

(73) Assignee: Valeo Systemes Thermiques, Le Mesnil St Denis (FR)

(21) Appl. No.: 11/639,007

(22) Filed: Dec. 14, 2006

(30) Foreign Application Priority Data
Dec. 21, 2005 (FR) 0513012

(51) Int. Cl. B60L 1/02

(52) U.S. Cl. 219/202

(57) ABSTRACT

The invention relates to an electric-type heating device 1, particularly intended to heat an air flow passing through a motor vehicle ventilation, heating and/or air-conditioning system, comprising:
a heating unit 2 consisting of a frame 4 wherein at least one heating element 5 is fitted,
a connector 3 intended to connect the heating element 5 to an electrical power supply from the vehicle, characterized in that the connector 3 comprises a first interface 30 intended to be connected to the heating element and a second interface 17 intended to be connected to the electrical power supply from the vehicle. Application to electric radiators for a motor vehicle.

The technical field of the present invention is that of electric-type heating or radiator devices intended to be fitted in a motor vehicle ventilation, heating and/or air-conditioning system.

It particularly relates to a so-called additional heating radiator equipped with electrical resistors, for example positive temperature coefficient (PTC) resistors, to provide practically immediate additional heating in heat-deficient vehicles at the time of ignition.

The radiators according to the prior art comprise a heating unit wherein the air flow to be heated inside the vehicle ventilation, heating and/or air-conditioning passes. These electric radiators are designed according to the motor vehicle manufacturer's requirement, i.e. the space allocated to integrate such a radiator and the type and shape of the connector present on the wiring harness of the vehicle. In fact, the electrodes conducting the electrical current to the PTC-effect stones are shaped so as to extend into the coupling connector. Each radiator has a connector shape capable of receiving the wiring harness connectors differing from one motor vehicle manufacturer to another.

This disparity in the shape of the connectors results in major drawbacks.

One of the main drawbacks is that it is not possible to standardize the common parts of the specific radiators for each manufacturer, resulting in an increase in production costs accompanied by an increase in logistic-related costs. In fact, the various radiator references require complex and costly stock management.

Therefore, the purpose of the present invention is to resolve the drawbacks described above essentially by standardizing the production of the radiator heating unit and by offsetting the adaptation, i.e. to the manufacturer's connector, to a smaller part, less costly to produce and easier to store. This part is a connector providing the mechanical and electrical link between the heating unit and the manufacturer's connectors, said connector comprising a first standardized interface to be fitted on the heating unit and a second modular interface, adaptable according to the shape of the connector fitted on the manufacturer's wiring harness.

In the same perspective, the electronic control of the heating device is frequently dependent on each of the motor vehicle manufacturers, which also prevents the standardization of the items forming an electric radiator. For this reason, the heating device according to the invention does not comprise an electronic control module and is restricted to the power part of the electric radiator.

Therefore, the invention relates to an electric-type heating device, particularly intended to heat an air flow passing through a motor vehicle ventilation, heating and/or air-conditioning system, comprising:

a heating unit consisting of a frame wherein at least one heating element is fitted,

a connector intended to connect the heating element to an electrical power supply from the vehicle, characterized in that the connector comprises a first interface intended to be connected to the heating element and a second interface intended to be connected to the electrical power supply from the vehicle.

According to a first characteristic of the invention, the connector comprises at least two electrical wires connected on one side to the heating element and on the other to the electrical power supply.

According to a second characteristic of the invention, the heating element consists of two electrodes between which two heat sinks are fitted, the two heat sinks encompassing at least one PTC-effect stone, said stone and the heat sinks being connected by bonding.

According to another characteristic of the invention, at least one of the electrical wires is connected in a non-removable manner to at least one of the electrodes of the heating element.

According to another characteristic of the invention, the second interface cooperates in a non-removable manner with an additional connector electrically connected to the vehicle electrical power supply via a wiring harness.

According to another characteristic of the invention, the additional connector takes the form of a male part capable of being inserted into a female part formed in the second interface.

The first interface comprises at least one retention means to secure the connector on the frame.

Advantageously, the second interface comprises at least one additional connector retention means when the male part is inserted into the female part.

More advantageously, the first interface is standardized while the second interface is adaptable to the shape of the additional vehicle wiring harness connector.

The invention also relates to a heating device assembly method, said device comprising a heating unit consisting of a frame wherein at least one heating element and one connector intended to connect the heating element to an electrical power supply from a vehicle are fitted, said method consisting of:

attaching the connector to the frame using retention means,

connecting at least one electrical wire of said connector in a non-removable manner to the heating element.

Other characteristics, details and advantages of the invention will emerge more clearly on reading the description given below as an indication with reference to figures. These figures may not only be used to clarify the understanding of the present invention, but also contribute to the definition thereof, if applicable. These figures are:

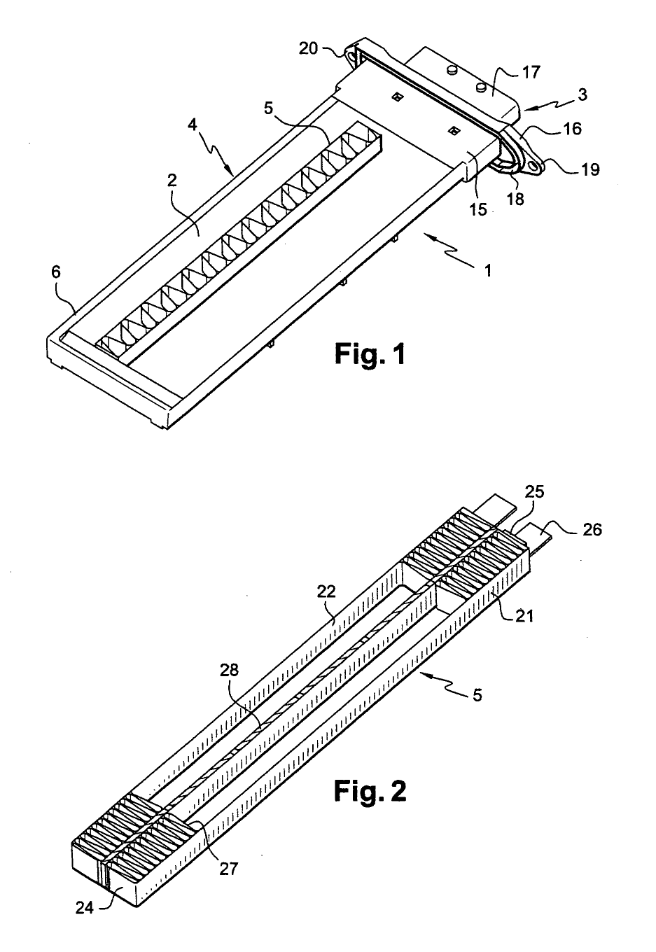

FIG. 1 is a perspective view of a heating device or heat sink according to the invention,

FIG. 2 is a detailed view showing the composition of a heating element of the heating device according to the invention,

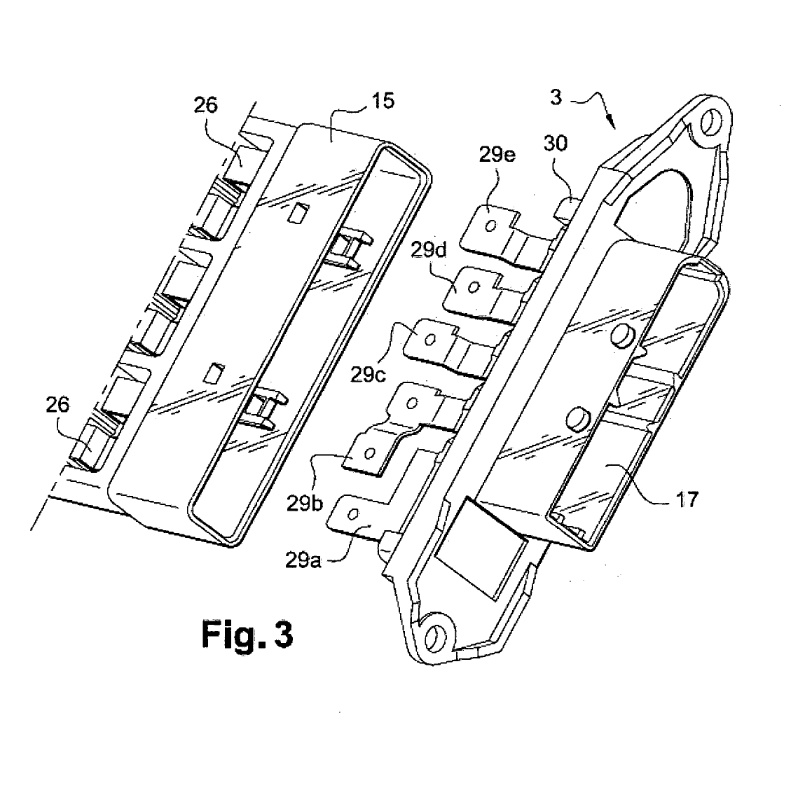

FIG. 3 is a perspective view of the connector detached from the heating unit in the device according to the invention,

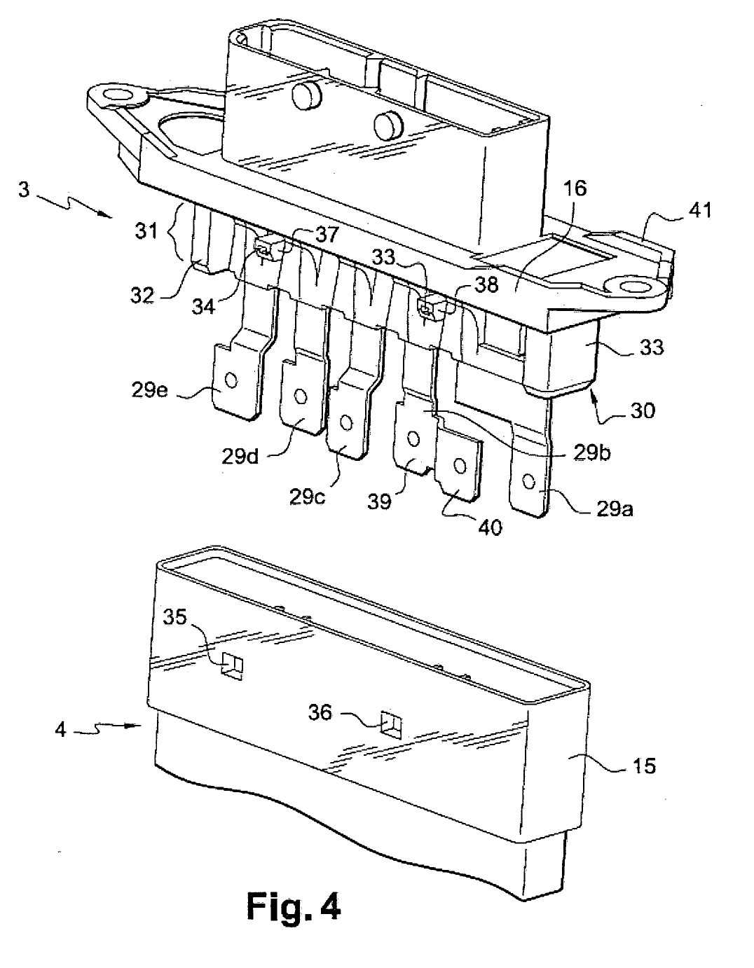

FIG. 4 is a detailed view of FIG. 3,

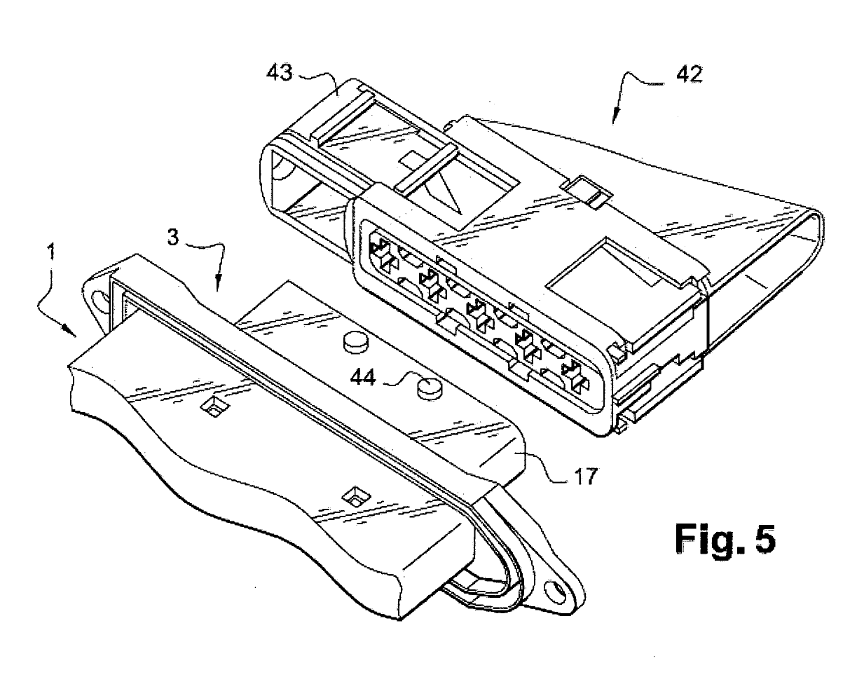

FIG. 5 is a view showing the source connector in the vicinity of the heating device connector according to the invention.

FIG. 1 shows an electric-type heating device 1 intended to heat an air flow. This type of electric radiator is used in motor vehicles to provide practically immediate additional heat. It is generally placed transversally in the main air stream of the system so as to convert the electrical energy extracted from the vehicle into thermal energy returned to the air passing through the air-conditioning system. The heating device 1 according to the invention does not comprise an electronic control module. In fact, the control of this electric radiator is located elsewhere on the vehicle, for example in an electronic air-conditioning computer or in an electronic vehicle interior computer.

This device consists of a heating unit 2 and a connector 3, the latter is used to connect the electric radiator electrically to the power supply or source on the vehicle.

The heating unit 2 consists of a plastic frame 4, for example made of polypropylene or polyamide, inside which heating elements 5 are integrated. Each element is capable of dissipating an output of the order of 330 Watts. The electrical radiator comprises three heating elements so that this electric radiator can dissipate a total output of approximately 1000 Watts.

The heating zone of the frame 4 is ended by a housing 15 of substantially the same size as the heating zone, i.e. this housing extends along the width of the heating zone. This housing 15 receives the connector 3, which comprises a first interface (described in detail with reference to FIG. 4), which extends inside the housing 15, the accessible part consisting of an approach edge 16 and a second interface 17 intended to be connected to the electrical power supply from the vehicle.

The approach edge 16 comprises a peripheral groove 18 wherein a seal may be positioned so as to ensure the air-tightness between the inside of the air-conditioning system where the frame 4 extends and the outside of the system where the approach edge 16 and the second interface 17 extend. The approach edge 16 also comprises two lugs 19 and 20, which extend laterally and through which an attachment hole is provided. These attachment holes in combination with the frame 4 make it possible to hold the electric radiator firmly in position in the ventilation, heating and/or air-conditioning system.

FIG. 2 shows a heating element 5 also referred to as a bar heater. This heating element consists of two conductive electrodes 21 and 22 extending longitudinally. Each of these electrodes has a general “C” shape in its longitudinal plane as both ends 24 and 25 of the electrode are doubled toward the same point. The end referenced 25 also comprises an ending 26 formed by bending the electrode 21. For example, the material used for the production of the electrode is brass or tin-coated copper, or aluminum. The “C” shape of the electrode makes it possible to enclose a metal tape doubled onto itself at regular intervals so as to form a thermal heat sink 27 also referred to as an insert. For reasons of clarity, the thermal heat sinks 27 are represented only partially, the part not shown being identical to the representation shown in FIG. 2.

Therefore, the heating element 5 comprises two electrodes 21 and 22 positioned opposite each other. These two electrodes encompass the two thermal heat sinks 27 to rest against PTC-effect stones 28 (Positive Temperature Coefficient). In the example represented in this figure, it is noted that the heating element 5 comprises six PTC-effect stones 28 spaced at a slight interval from each other.

The PTC-effect stones 28 are kept attached to the heat sinks 27 by means of a thermal adhesive, which is sufficiently strong to provide an electrical contact between the heat sink 27 and the PTC-effect stone 28.

It should be noted that the electrodes 21 and their dedicated heat sinks 27 are passed through by different electrical potentials so as to supply both faces of the PTC-effect stone 28 electrically.

FIG. 3 shows an exploded view of the frame 4 and the connector 3. If three heating elements 5 of the type of those described with reference to FIG. 2 are installed in the frame 4, this gives a row of six endings 26 to be supplied with electrical energy.

In this case, the connector 3 comprises 5 electrical wires 29a to 29e connected on one side to the heating elements and on the other to the electrical power supply to the vehicle. This connector comprises a first interface 30 and the second interface 17.

The first interface 30 cooperates with the housing 15, which has an overall rectangular shape that defines an internal volume wherein the first interface 30 is inserted. It should be noted at this stage of the description that the shape of the elements described is not governed by the motor vehicle manufacturer's technical considerations.

The second interface 17 is the area to be adapted to the constraints of each motor vehicle manufacturer. In fact, the shape of this interface is governed by the specific shape of a source connector connected electrically to the electrical power supply of the vehicle via its wiring harness. This source connector may adopt different external shapes and comprise radically different locking means between manufacturers.

FIG. 4 is a more detailed representation of the connector 3 and the housing 15. The first interface 30 comprises a guiding zone 31 molded in the same material as that in which the connector 3 is made. The guiding zone 31 comprises two guides 32 and 33, which have a shape complementary to that of the internal volume of the housing 15 so as to slide in the housing 15. In addition, the guiding zone 31 comprises two attachment blocks 33 and 34 cooperating with the holes 35 and 36 made in the outer wall of the housing 15 so as to hold and secure the connector 3 on the frame 4. The attachment blocks 33 and 34 extend in the same plane as the approach edge 16 and each comprise a chamfer referenced 37 and 38 to facilitate the insertion of the first interface 30 in the housing 15. During this insertion, the walls of the housing 15 are deformed under the strain of the attachment blocks until said blocks enter their respective holes 35 and 36. The attachment blocks 33 and 34 and their respective holes 36 and 35 together define the retention means of the connector 3 in the frame 4.

It is noted in this figure that some of the electrical wires 29a to 29e power two heating elements at the same time. In fact, the wire 29b comprises a first end 39 and a second end 40. These two ends take the shape of an enlarged flat with respect to the electrical wire 29b and extend in two parallel but different planes.

It should also be noted that the approach edge 16 comprises, at its periphery, reinforcement zones 41 the purpose of which is to increase the mechanical strength of the approach edge.

When the connector 3 is inserted into the frame 4, the ends of the electrical wires 29a-29e are connected in a non-removable manner to the endings of the heating element electrodes. This non-removable connection is provided by welding, soldering, riveting, crimping so as to limit the contact resistances and reduce the size of the connection as much as possible.

FIG. 5 shows one end of the heating device 1 and a source connector 42 connected to the wiring harness (not shown) of the vehicle. This source connector 42 provides the electrical power required for the power supply of the heating device 1 and is mounted in a removable manner on the second interface 17 of the connector 3. The second interface 17 adopts the shape of a male part so as to be inserted into a female part represented by the source connector 42. This connector comprises retention means consisting of a catch 43 and at least one pin 44. The catch 43 slides into the source connector 42 when the latter is inserted into the second interface 17. In this case, the pins 44 cooperate with a slide produced in the inner wall of the catch 43.

It should be noted in the description below that there is no mention of any transistor or electronic control card-type control device integrated in the heating device, the latter being limited to easily standardizable components with the exception of the connector 3.

It should be understood that the connector 3 is a separate part of the frame 4 whose functions are to:

connect the source connector 42 of the vehicle electrically to the heating elements installed in the frame 4,

adapt to the specific shape of the source connector 42 by means of the second interface 17.

The invention also relates to the method for assembling a heating device 1 as described below, wherein:

the connector 3 is attached to the frame 4 using retention means (33, 34, 35, 36), particularly by means of the cooperation between the attachment blocks 33 and 34 and the corresponding holes 36 and 35,

at least one of the electrical wires 29a to 29e of the connector 3 connects electrically in a non-removable manner to at least one of the heating elements 5.

The description above refers to the use of PTC-effect stones, but the invention also covers an electric radiator using a PTC-type polymer. In this case, the PTC-effect polymer comes in the form of a band sandwiched between the heat sinks 27 and connected thereto by bonding.

In addition, it should naturally be understood that the electrical power supply of the vehicle via a wiring harness to the heating device according to the invention will be provided for example via switching devices located outside the heating device 1. These switching devices are for example relays, transistors and/or fuses.

1. Electric-type heating device (1), particularly intended to heat an air flow passing through a motor vehicle ventilation, heating and/or air-conditioning system, comprising:
a heating unit (2) consisting of a frame (4) wherein at least one heating element (5) is fitted,
a connector (3) intended to connect the heating element (5) to an electrical power supply from the vehicle, characterized in that the connector (3) comprises a first interface (30) intended to be connected to the heating element and a second interface (17) intended to be connected to the electrical power supply from the vehicle.

2. Heating device (1) according to claim 1, characterized in that the connector (3) comprises at least two electrical wires (29a-29e) connected on one side to the heating element (5) and on the other to the electrical power supply.

3. Heating device (1) according to any of claims 1 or 2, characterized in that the heating element (5) consists of two electrodes (21) between which two heat sinks (27) are fitted, the two heat sinks (27) encompassing at least one PTC-effect stone (28), said stone and the heat sinks being connected by bonding.

4. Heating device (1) according to claim 3, characterized in that at least one of the electrical wires (29a-29e) is connected in a non-removable manner to at least one of the electrodes (21) of the heating element (5).

5. Heating device (1) according to any of claims 1 to 4, characterized in that the second interface (17) cooperates in a non-removable manner with a source connector (42) electrically connected to the vehicle electrical power supply via a wiring harness.

6. Heating device according to any of claims 1 to 5, characterized in that the first interface (30) comprises at least one retention means (33, 34, 35, 36) to secure the connector (3) on the frame (4).

7. Heating device (1) according to any of claims 1 to 6, wherein the frame (4) comprises a housing (15), which receives in its internal volume the first interface (30), said first interface (30) and the heating unit (2) are standardized while the second interface (17) is adaptable to the shape of the source connector (42).

8. Method to assemble a heating device (1), said device comprising a heating unit (2) consisting of a frame (4) wherein at least one heating element (5) and one connector (3) intended to connect the heating element (5) to an electrical power supply from a vehicle are fitted, said method consisting of:
attaching the connector (3) to the frame (4) using retention means (33, 34, 35, 36),
connecting at least one electrical wire (29a-29e) of said connector (3) to the heating element (5).
